(19) United States
(12) Patent Application Publication
(10) Pub. No.: US 2026/0164140 A1
(43) Pub. Date: Jun. 11, 2026

(54) IMAGE PROCESSING SYSTEM

(71) Applicants: National Cheng Kung University, Tainan City (TW); Himax Technologies Limited, Tainan City (TW)

(72) Inventors: Yu-Xiang Zheng, Tainan City (TW); Ming-Der Shieh, Tainan City (TW); Chia-Chi Tsai, Tainan City (TW); Po-Chang Chen, Tainan City (TW)

(21) Appl. No.: 18/976,027

(22) Filed: Dec. 10, 2024

(51) Int. Cl. H04N 23/84; G06T 7/90; G06V 10/77; G06V 10/82; H04N 23/88; H04N 25/13

(52) U.S. Cl. CPC H04N 23/843; G06T 7/90; G06V 10/7715; G06V 10/82; H04N 23/88; H04N 25/13; G06T 2207/10024; G06T 2207/20081

(57) ABSTRACT

An image processing system includes an image sensor that converts light into a raw image; an image signal processor (ISP) that performs image processing on the raw image; a predictor that dynamically generates correction parameters; and a plurality of adders that respectively add the correction parameters and corresponding base parameters, sums of which are as adjusted parameters to be dynamically fed to the ISP.

### BACKGROUND OF THE INVENTION

### 1. Field of the Invention

The present invention generally relates to an image processing system, and more particularly to an image processing system adaptable to computer vision tasks.

### 2. Description of Related Art

An image signal processor (ISP) is a specialized digital signal processor used in digital cameras and other imaging devices to process the raw data captured by an image sensor.

The evolution of image signal processing (ISP) reflects a significant shift in the application of vision technology. As neural networks become increasingly central to machine vision, the traditional focus on human-centric image clarity and aesthetics is being reevaluated. Researchers are now exploring how ISPs can be restructured or optimized to better serve machine analysis needs. This involves rethinking the entire pipeline, from sensor data acquisition to the final image output, to ensure that the processed images are more conducive to algorithmic interpretation and analysis. By tailoring ISPs to the requirements of neural network-based vision systems, there is potential to greatly enhance the accuracy and efficiency of tasks such as object recognition, scene understanding, and autonomous navigation. This optimization could lead to breakthroughs in fields ranging from automated driving to robotic surgery, where precision and reliability of machine vision are paramount.

Image Signal Processors (ISPs) play a crucial role in the performance of neural network-based vision systems. They are responsible for converting raw image data into a format suitable for both training and inference phases of neural networks. By preprocessing the images, ISPs enhance features, reduce noise, and correct colors, which can significantly improve the accuracy of the subsequent machine learning tasks. The processed images become the dataset that the neural network learns from during training and the input it analyzes during inference, making the ISP an indispensable component in modern computer vision applications.

The optimization of Image Signal Processing (ISP) through neural networks is a sophisticated field that aims to enhance image quality and object detection capabilities. Direct parameter prediction, a method where the neural network's outputs are used as ISP parameters, has shown promise in improving object detection, especially in challenging conditions. However, the difficulty in defining effective parameter value ranges for various ISPs and datasets can hinder the network's ability to converge during training.

For the foregoing reasons, a need has thus arisen to propose a novel scheme to overcome the drawbacks of the conventional image signal processing (ISP) systems.

### SUMMARY OF THE INVENTION

In view of the foregoing, it is an object of the embodiment of the present invention to provide an image processing system capable of dynamically adjusting parameters for an image signal processor.

According to one embodiment, an image processing system includes an image sensor, an image signal processor (ISP), a predictor and a plurality of adders. The image sensor converts light into a raw image. The ISP performs image processing on the raw image. The predictor dynamically generates correction parameters. The adders respectively add the correction parameters and corresponding base parameters, sums of which are as adjusted parameters to be dynamically fed to the ISP.

### BRIEF DESCRIPTION OF THE DRAWINGS

FIG. 1 shows a block diagram illustrating an image processing system according to one embodiment of the present invention;

FIG. 2A shows a block diagram illustrating the predictor of FIG. 1; and

FIG. 2B shows a detailed block diagram of the predictor of FIG. 2A.

### DETAILED DESCRIPTION OF THE INVENTION

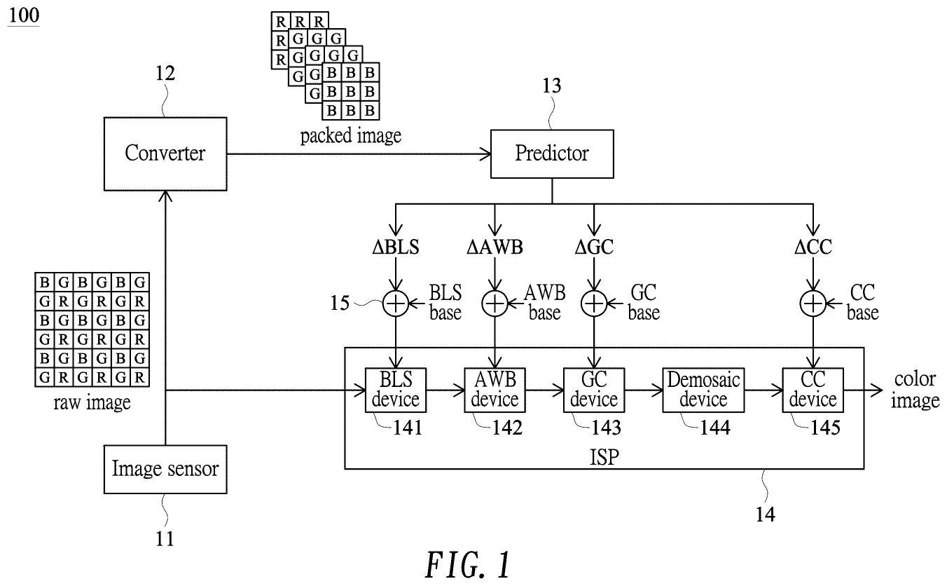

FIG. 1 shows a block diagram illustrating an image processing system 100 according to one embodiment of the present invention adaptable to computer vision tasks such as, but not limited to, face detection.

Specifically, the image processing system 100 of the embodiment may include an image sensor 11 configured to convert light into a raw image composed of color signals such as red signals, green signals and blue signals. The image sensor 11 may be overlaid with a color filter array such as a Bayer filter having a filter pattern with half green (G), one quarter red (R) and one quarter blue (B).

In the embodiment, the image processing system 100 may include a converter 12 configured to pack same color signals of the raw image, thereby resulting in a packed image. As schematically exemplified in FIG. 1, the converter 12 packs the color signals of the raw image into BGGR (blue/green/green/red) format, which has more layers (e.g., four layers) but reduced size (e.g., half height and half width). The packed image converted by the converter 12 facilitates subsequent processing, allowing computation amount to be substantially reduced while maintaining accuracy.

The image processing system 100 may include a predictor 13 configured to dynamically generate or predict correction (or residual) parameters for an image signal processor (ISP) 14 according to the packed image. In the embodiment, the predictor 13 may generate a black level subtraction (BLS) correction parameter Δ BLS, an auto white balance (AWB) correction parameter Δ AWB, a gamma correction (GC) correction parameter Δ GC and a color correction (CC) parameter Δ CC. In the embodiment, the correction parameters are generated based on a residual prediction method, details of which may be referred to Ziteng Cui et al. “You only need 90 k parameters to adapt light: A light weight transformer for image enhancement and exposure correction,” published in British Machine Vision Conference, 2022, contents of which are incorporated herein by reference.

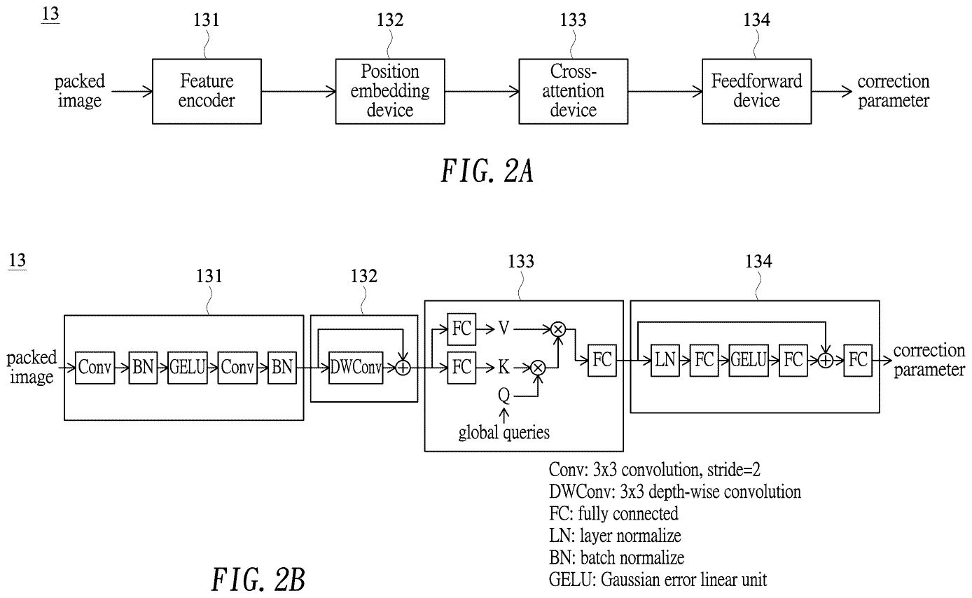

FIG. 2A shows a block diagram illustrating the predictor 13 of FIG. 1, and FIG. 2B shows a detailed block diagram of the predictor 13 of FIG. 2A.

Specifically, the predictor 13 of the embodiment may include a feature encoder 131 that uses two convolutional layers with a stride of 2 to extract features from the packed image while reducing the resolution of a feature map representing an output of the convolutional layers (in convolutional neural networks). The feature map captures specific features from an input image or previous layer's output by applying filters (kernels) during the convolution process.

The predictor 13 may include a position embedding device 132 that adopts depth-wise convolution in convolutional neural networks to reduce computational complexity and improve efficiency. The predictor 13 may include a cross-attention device 133 that performs cross-attention with global queries, each of which represents a parameter to be predicted. Therefore, if we need to predict a total of N correction parameters, we will set N learnable queries. The predictor 13 may include a feedforward device 134 that decodes the features and reduces their dimensions, resulting in the predicted correction parameters.

Referring back to FIG. 1, the image processing system 100 of the embodiment may include a plurality of adders 15 configured to respectively add the correction parameters and corresponding base parameters (e.g., BLS, AWB, GC and CC base parameters), sums of which are as adjusted parameters to be dynamically fed to the image signal processor (ISP) 14 that is configured to perform image processing on the raw image, thereby generating a color image such as an RGB image. It is noted that generating correction parameters and combining them with base parameters instead of directly generating adjusted parameters can make the system stable and easily controlled within the effective range.

In the embodiment, the base parameters may be obtained according to the following process. First, a plurality of candidate modules are connected in series as interconnected image processing stages to implement an ISP supernet. In one embodiment, each candidate module may include BLS, AWB, CC and GC operations. It is noted that the ISP supernet may include one demosaic component, and candidate modules before the demosaic component is in raw domain while candidate modules after the demosaic component is in RGB domain. Subsequently, we train a pre-trained model (i.e., the vision application model, such as face detection, face recognition, etc.), and embed the ISP supernet into the training framework. Through the trained supernet, we can obtain probability distribution for each stage. Then, by selecting the operation with the highest probability for each stage, we can derive the final searched ISP. Next, we retrain the searched ISP to optimize the parameters, thereby obtaining the final optimal ISP and the base parameters.

In the embodiment, the ISP 14 may include a black level subtraction (BLS) device 141 coupled to receive an image represented by the raw image and configured to correct a black level of the image according to a BLS adjusted parameter (which is a sum of the BLS correction parameter Δ BLS and the BLS base parameter). Specifically, BLS involves adjusting the color signals to remove any offset that might be present in the image. This offset can be due to various factors, such as sensor pre-defined black level, dark current, electronic noise and other sensor imperfections. The main goal of BLS is to correct the black level to 0 (or a value close to 0), and to remove the black level such that the pixel data is left with only the signal component caused by light. For each pixel at coordinates(x,y), the black level subtraction and value normalization are performed, followed by clamping values to a valid range. Specifically, given an (8-bit) input image Iᵢₙₚᵤₜ and a determined black level b, the BLS processed image IBLS can be obtained as follows:

$${I}_{corrected} ( x , y ) = ( {I}_{input} ( x , y ) - b ) / ( 255 - b )$$

$${I}_{BLS} ( x , y ) = min ( max ( {I}_{corrected} ( x , y ) , 0 ) , 255 )$$

In the above example, the pixel data is 8 bit with the maximum value of 255. The expression (255-b) in the denominator of the first formula represents normalization or data range extension. The second formula clamps the data between 0 and 255 to avoid overflow or underflow by functions min( ) and max( ). A BLS parameter may primarily refer to a black level offset, which defines a value to be subtracted from each pixel to achieve proper black level and to compensate for any black level error or dark current present in the image sensor 11.

In the embodiment, the ISP 14 may include an auto white balance (AWB) device 142 coupled to receive an output from the BLS device 141 and configured to adjust colors in the image represented by the raw image according to an AWB adjusted parameter (which is a sum of the AWB correction parameter Δ AWB and the AWB base parameter). Specifically, AWB multiplies each color channel by a gain to adjust the color tint. The purpose is to improve the accuracy of the vision application task of the pre-trained model, and to improve machine vision performance. It is noted that, as the embodiment of the present invention focuses on improving machine vision performance, AWB does not necessarily correct white objects to be white. With this flexibility and margin, the overall performance can be further improved. An AWB parameter may primarily refer to gains respectively applied to red, green and blue channels to adjust the color tint.

In the embodiment, the ISP 14 may include a gamma correction (GC) device 143 coupled to receive an output from the AWB device 142 and configured to perform a nonlinear operation to adjust luminance (or brightness) of the image represented by the raw image, by applying a power-law transformation, according to a GC adjusted parameter (which is a sum of the GC correction parameter Δ GC and the GC base parameter). It is noted that the gamma correction of the embodiment of the present invention aims at optimizing machine vision applications. Therefore, the gamma correction of the embodiment is utilized as a tone mapping, which moderately strengthens the image contrast to improve the accuracy of the pre-trained model. The GC parameter may primarily refer to a gamma value (γ), which is an exponent in the power-law expression used for gamma correction. The gamma value influences the shape of the correction curve.

In the embodiment, the ISP 14 may include a demosaic device 144 coupled to receive an output from the GC device 143 and configured to reconstruct a full-color image from the incomplete color samples output by the image sensor 11 overlaid with the color filter array (CFA) such as the Bayer filter. The goal of demosaic is to estimate the missing color information for each pixel in the image. Since each pixel in a CFA captures only one of the three primary colors (red, green or blue), demosaic technique interpolates the missing colors to produce a complete RGB image.

In the embodiment, the ISP 14 may include a color correction (CC) device 145 coupled to receive an output from the demosaic device 144 and configured to adjust colors in the image represented by the raw image according to a CC adjusted parameter (which is a sum of the CC correction parameter Δ CC and the CC base parameter). It is noted that the color correction of the embodiment of the present invention aims at optimizing machine vision applications. Therefore, the color correction of the embodiment is utilized as a color adjustment or color feature enhancement, allowing the pre-trained model to further improve the accuracy. The CC parameter may primarily refer to a color correction matrix (CCM), which is a matrix used to transform colors from the camera's color space to a standard color space. The CCM compensates for the color response of the image sensor 11.

It is noted that the BLS device 141, the AWB device 142, the GC device 143, the demosaic device 144 and the CC device 145 may be arranged in an order different from that shown in FIG. 1. Although the computation amount of the shown arrangement is not the least, however the performance (or detection accuracy) is optimized.

Although specific embodiments have been illustrated and described, it will be appreciated by those skilled in the art that various modifications may be made without departing from the scope of the present invention, which is intended to be limited solely by the appended claims.

What is claimed is:

1. An image processing system, comprising:
an image sensor that converts light into a raw image;
an image signal processor (ISP) that performs image processing on the raw image;
a predictor that dynamically generates correction parameters; and
a plurality of adders that respectively add the correction parameters and corresponding base parameters, sums of which are as adjusted parameters to be dynamically fed to the ISP.

2. The system of claim 1, further comprising:
a converter that packs same color signals of the raw image to result in a packed image, which is fed to the predictor before generating the correction parameters.

3. The system of claim 2, wherein the converter packs the color signals of the raw image into BGGR format, where B represents blue color, G represents green color and R represent red color.

4. The system of claim 1, wherein the ISP comprises:
a demosaic device that reconstructs a full-color image from incomplete color samples from the image sensor.

5. The system of claim 4, wherein the ISP further comprises:
a black level subtraction (BLS) device that corrects a black level of the raw image according to a BLS adjusted parameter;
an auto white balance (AWB) device that adjusts colors in an image represented by the raw image according to an AWB adjusted parameter;
a gamma correction (GC) device that performs a nonlinear operation to adjust luminance of the image represented by the raw image according to a GC adjusted parameter; and
a color correction (CC) device that adjusts colors in the image represented by the raw image according to a CC adjusted parameter.

6. The system of claim 5, wherein the BLS device receives the raw image, the AWB device receives an output from the BLS device, the GC device receives an output from the AWB device, the demosaic device receives an output from the GC device, and the CC device receives an output from the demosaic device.

7. The system of claim 5, wherein the predictor generates a BLS correction parameter, an AWB correction parameter, a GC correction parameter and a CC parameter, which are respectively added to a BLS base parameter, an AWB base parameter, a GC base parameter and a CC base parameter, thereby resulting in a BLS adjusted parameter, an AWB adjusted parameter, a GC adjusted parameter and a CC adjusted parameter for the BLS device, the AWB device, the GC device and the CC device respectively.

8. The system of claim 7, wherein the BLS adjusted parameter comprises a black level offset defining a value to be subtracted from each pixel, the AWB adjusted parameter comprises gains respectively applied to red, green and blue channels, the GC adjusted parameter comprises a gamma value that is an exponent in power-law expression used for gamma correction, and the CC adjusted parameter comprises a color correction matrix used to transform colors.

9. The system of claim 5, wherein the image sensor is overlaid with a color filter array.

10. The system of claim 9, wherein the color filter array comprises a Bayer filter.

11. The system of claim 1, wherein the predictor comprises:
a feature encoder that extracts features from the raw image;
a position embedding device that adopts depth-wise convolution to reduce computational complexity;
a cross-attention device that performs cross-attention with global queries, each of which represents a parameter to be predicted; and
a feedforward device that decodes the features and reduces dimensions thereof, thereby resulting in the correction parameters.
